(19) United States
(12) Patent Application Publication
(10) Pub. No.: US 2016/0110714 A1
(43) Pub. Date: Apr. 21, 2016

(54) Encapsulated Digital Remittance Solution Within Messaging Application

(71) Applicant: Kim Ramsoe Norland, Henderson, NV (US)

(72) Inventor: Kim Ramsoe Norland, Henderson, NV (US)

(21) Appl. No.: 14/919,232

(22) Filed: Oct. 21, 2015

Related U.S. Application Data
(60) Provisional application No. 62/066,552, filed on Oct. 21, 2014.

(51) Int. Cl. G06Q 20/40; G06Q 20/32

(52) U.S. Cl. CPC G06Q 20/401; G06Q 20/325; G06Q 2220/00

(57) ABSTRACT

An encapsulated digital remittance solution that provides a remote money transfer server and a digital money transfer application installed on a personal computing device. The digital money transfer application integrates a money transfer shortcut into a digital interface of a digital messaging application, wherein the digital money transfer application can be launched from within the digital messaging application. When the money transfer shortcut is selected, the digital money transfer application initiates an encrypted connection between the personal computing device and the remote money transfer server to ensure the secure transfer of information. A currency transfer amount and a transfer recipient are selected by a user through a money transfer interface displayed within the digital messaging application. A money transfer confirmation is then generated and sent to the transfer recipient via the digital messaging application. Money is the digitally transferred between account via the remote money transfer server.

The current application claims a priority to the U.S. Provisional Patent application serial number 62/066,552 filed on Oct. 21, 2014.

### FIELD OF THE INVENTION

The present invention relates generally to digital money transfer. More specifically, the present invention is an encapsulated remittance application that is launched from within a digital messaging application and allows for both domestic and international money remittance.

### BACKGROUND OF THE INVENTION

With the growing popularity of personal electronics, many consumers prefer to utilize digital, electronic payments over physical checks or money orders. However, in the area of remittance, (herein defined as “money transfer” or “international money transfer”) the majority of transactions are done physically at money collection offices or via stand-alone digital applications. The use of digital applications to perform monetary transactions is becoming increasingly common as it presents a convenient and quick method of transferring money from one account to another. Furthermore, the digital applications allow a user to transfer money from almost any physical location provided they have a data connection.

Digital applications are not only becoming popular for monetary transactions but also for general communication between individuals. Communication between friends and relatives is increasingly moving from voice chats to texting, email, or messaging on social media applications. As users commonly utilize social media applications to communicate, the topic of remittance often arises. During the course of a conversation, if one user wishes to send remittance, the user is required to jump applications in order to open the money transfer application. This “jump” from a digital messaging application to a money transfer application can often be disruptive to the flow of communication and is a nuisance.

Therefore it is the object of the present invention to provide an encapsulated digital remittance solution that provides a remote money transfer server and a digital money transfer application installed on a personal computing device. The digital money transfer application integrates a money transfer shortcut into a digital messaging application, wherein the digital money transfer application can be launched from within the digital messaging application. The money transfer shortcut is integrated into a digital interface of the digital messaging application, such as a digital keyboard or a digital toolbar. When a user selects the money transfer shortcut from within the digital messaging application, the digital money transfer application is launched. The digital money transfer application then initiates an encrypted connection between the personal computing device and the remote money transfer server to ensure the secure transfer of information. A currency transfer amount and a transfer recipient are selected by the user through a money transfer interface of the digital money transfer application. A money transfer confirmation is then generated and sent to the transfer recipient via the digital messaging application. Money is then digitally transferred between account via the remote money transfer server.

### BRIEF DESCRIPTION OF THE DRAWINGS

FIG. 1 is a diagram of the digital interface of a digital messaging application.

FIG. 2 is a diagram of the digital messaging application, wherein an existing icon in the digital keyboard is replaced with the money transfer shortcut.

FIG. 3 is a diagram of the money transfer interface, wherein a user can upload money to the payments account.

FIG. 4 is a diagram of the money transfer interface displaying a plurality of payment options.

FIG. 5 is a diagram wherein the user has entered a currency upload amount.

FIG. 6 is a diagram displaying a plurality of input fields for entering the payment processing data.

FIG. 7 is a diagram further displaying the plurality of input fields for entering the payment processing data.

FIG. 8 is a diagram displaying an upload confirmation for the currency upload amount.

FIG. 9 is a diagram of the money transfer interface, wherein the currency balance has been increased by the currency upload amount.

FIG. 10 is a diagram of the money transfer interface, wherein the currency transfer amount has been entered.

FIG. 11 is a diagram of the money transfer interface, wherein a plurality of contacts is displayed for selecting the transfer recipient.

FIG. 12 is a diagram of the money transfer interface displaying a transfer confirmation for the transferred funds.

FIG. 13 is a diagram depicting the money transfer confirmation being sent to the transfer recipient via the digital messaging application.

FIG. 14 is a diagram depicting the money transfer confirmation received by the transfer recipient.

FIG. 15 is a diagram of the money transfer interface after the transfer recipient has selected the transfer link in the money transfer confirmation.

FIG. 16 is a diagram of the money transfer interface for selecting the subsequent third party account into which funds are deposited.

FIG. 17 is a diagram showing the subsequent third party account selected by the transfer recipient.

FIG. 18 is a diagram showing confirmation that funds have been transferred to the subsequent third party account selected by the transfer recipient.

FIG. 19 is a flowchart depicting the steps for transferring funds to a transfer recipient through the digital messaging application.

FIG. 20 is a flowchart further depicting the step for integrating the money transfer shortcut into the digital interface of the digital messaging application.

FIG. 21 is a flowchart further depicting the steps for uploading funds into the payments account, if the currency transfer amount is greater than the currency balance.

FIG. 22 is a flowchart further depicting the different processes through which the payment processing data can be obtained.

FIG. 23 is a flowchart further depicting the steps of transferring funds in an increment equal to the currency transfer amount.

FIG. 24 is a flowchart further depicting the steps for converting the currency transfer amount from a first currency to a second currency.

FIG. 25 is a flowchart further depicting the step for selecting the transfer recipient from a plurality of contacts.

FIG. 26 is a flowchart further depicting the steps validating that the personal computing device is a registered device.

FIG. 27 is a flowchart further depicting the steps digitally transferring the funds to the transfer recipient.

### DETAIL DESCRIPTIONS OF THE INVENTION

All illustrations of the drawings are for the purpose of describing selected versions of the present invention and are not intended to limit the scope of the present invention.

The present invention is an encapsulated digital remittance solution that provides a remote money transfer server, and a digital money transfer application installed on a personal computing device. The digital money transfer application is launched from within a digital messaging application, wherein the digital money transfer application is opened and utilized from within the digital messaging application. In this way, the user never has to leave the digital messaging application and can resume correspondence, uninterrupted upon closing the digital money transfer application.

In the preferred embodiment of the present invention, the digital money transfer application is independent of the digital messaging application. It is also possible for the digital money transfer application to be integrated into other applications, such as a banking application, e-commerce application, social media application, etc. In other embodiments of the present invention, it is possible for the digital money transfer application to be integrated directly into the digital messaging application or other application, such as a banking application or e-commerce application.

The remote money transfer server handles the monetary transactions between various payment accounts. This includes a payments account for a user, as well as third party payment accounts. Payments are transferred from a first third party account to the payments account, wherein the payments account provides the current available funds that the user can transfer to another individual. Available funds can then be transferred from the payments account of the user to a second third party account held by the individual receiving funds.

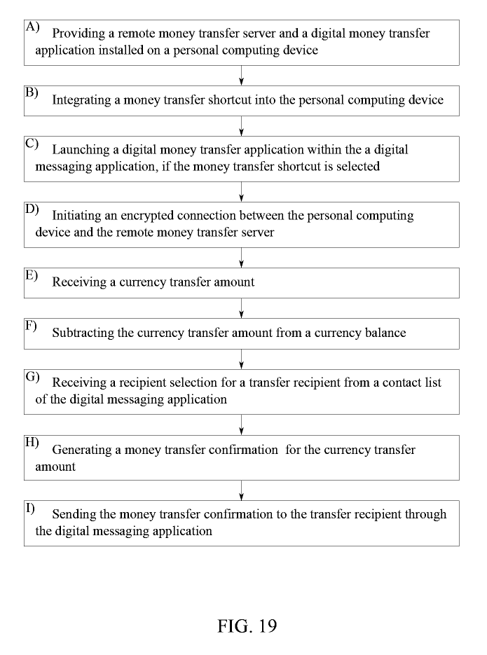

In reference to FIG. 19, when the digital money transfer application is installed on the personal computing device, the digital money transfer application integrates a money transfer shortcut into the personal computing device. The money transfer shortcut allows the user to launch the digital money transfer application from within the digital messaging application, therefore eliminating the need to switch between applications or close the digital messaging application. The money transfer shortcut can be integrated into a digital interface of the digital messaging application by either replacing an existing icon within the digital interface or adding the money transfer shortcut to the digital interface as an additional icon.

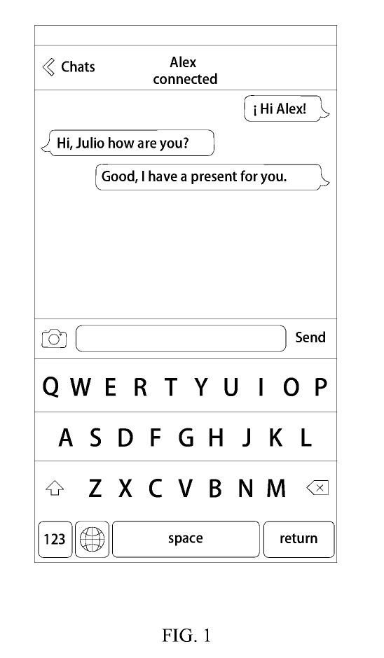

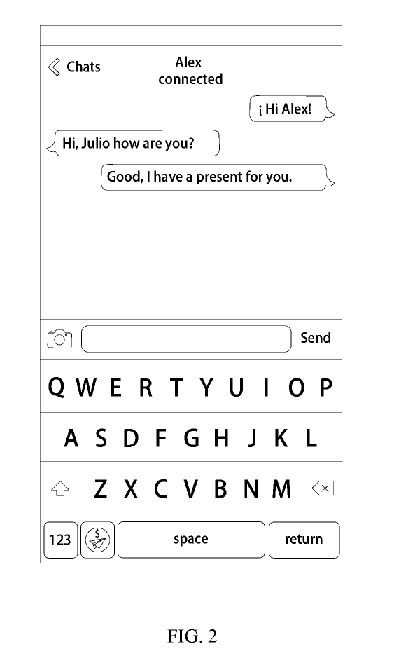

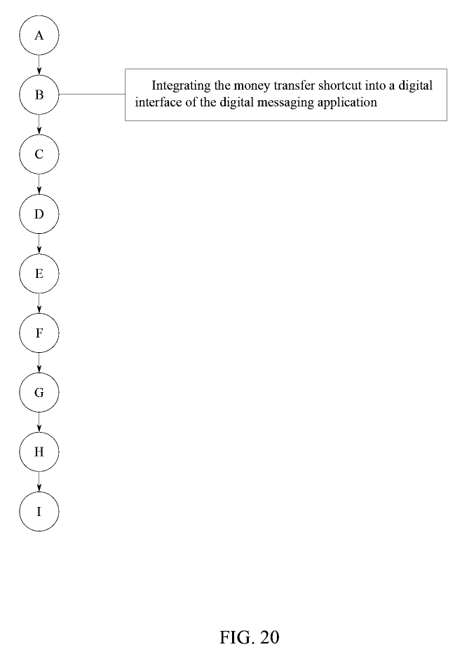

In reference to FIG. 20, in the preferred embodiment of the present invention, the money transfer shortcut is integrated into the digital interface being a digital keyboard. For example, in the digital keyboard that is standard for smartphones, the emoticon icon, being the existing icon, is replaced with the money transfer shortcut as can be seen between FIG. 1 and FIG. 2. As another example, the money transfer shortcut can be added to the digital keyboard of the digital messaging application as an emoji, wherein pressing or sending the emoji initiates the money transfer shortcut. In other embodiments, the money transfer shortcut is integrated into the digital interface being a digital toolbar. For example, in an email client or a web browser, the money transfer shortcut can be added to the digital toolbar, wherein the money transfer shortcut is the additional icon.

In yet other embodiments of the present invention, the money transfer shortcut can be integrated into the personal computing device as a voice command or a motion command. By using the microphone or motion sensors (e.g. accelerometer or gyroscope) of the personal computing device, the user can initiate the money transfer shortcut by the voice command or the motion command respectively. The voice command can be a preprogrammed word or phrase, or a word or phrase that is chosen by the user. Similarly, the motion command can be a preprogrammed movement of the personal computing device (e.g. shaking the personal computing device), or a movement selected by the user. The voice command or the motion command allows the user to initiate the money transfer shortcut from either within the digital messaging application or outside of the digital messaging application.

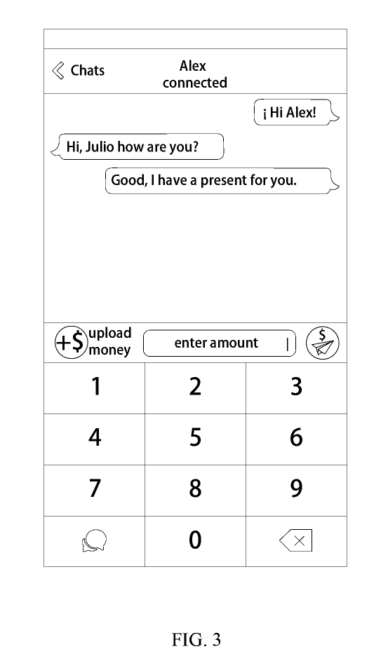

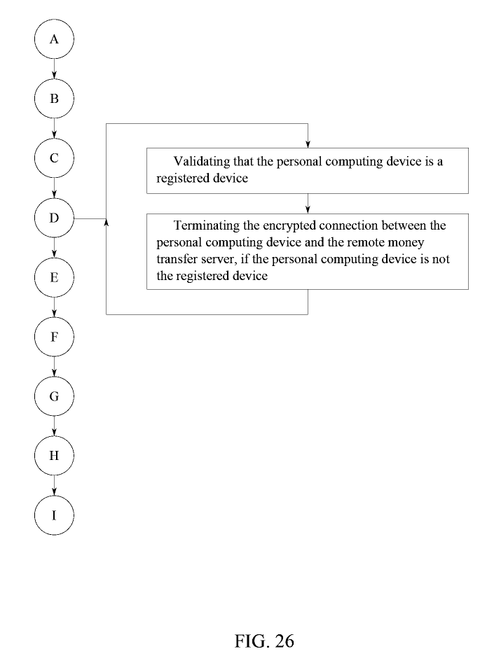

In reference to FIG. 19, when the digital money shortcut is selected by being pressed, clicked, etc., the digital money transfer application is launched within the digital messaging application as shown in FIG. 3. The digital money transfer application then initiates an encrypted connection between the personal computing device and the remote money transfer server. Additionally, and in reference to FIG. 26, the digital money transfer application validates that the personal computing device is a registered device. The digital money transfer application checks the phone number or other unique identifier of the personal computing device to ensure that the personal computing device is the registered device. If the personal computing device is not validated as the registered device, then the digital money transfer application terminates the encrypted connection between the personal computing device and the remote money transfer server to ensure the user's information is not compromised.

Once the encrypted connection has been established between the personal computing device and the remote money transfer server, and the digital money transfer application has validated that the personal computing device is the registered device, the user can transfer funds to a transfer recipient selected from a contact list of the digital messaging application. When the digital money transfer application is open within the digital messaging application, the user is presented with a money transfer interface that allows the user to select a currency transfer amount, as well as the transfer recipient. The money transfer interface may be displayed overtop an existing interface, or displayed as a separate interface depending on the application within which the digital money transfer application is launched.

In the preferred embodiment of the present invention, the money transfer interface replaces or overlays the digital keyboard of the digital messaging application as depicted between FIG. 2 and FIG. 3. In this way, the user can still view the current conversation. For example, if the digital messaging application is a text messaging application, then the digital keyboard on the bottom half of the screen is replaced or overlaid with the money transfer interface, while the top half of the screen displays the text conversation. In other embodiments of the present invention, the money transfer interface may be displayed as a pop-out, such as in a new tab for a web browser or a new window for an email client.

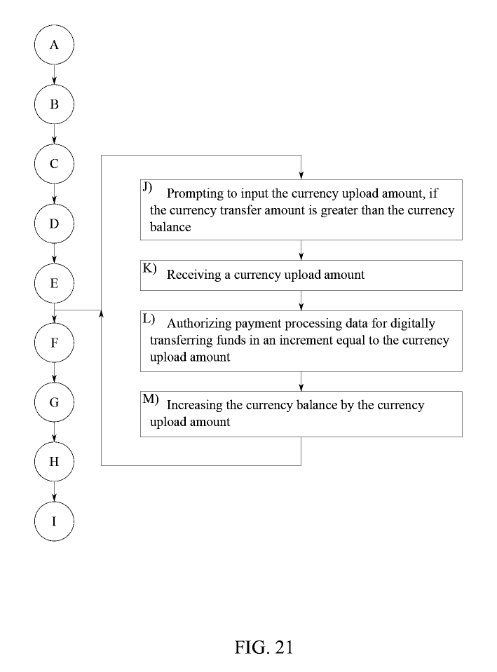

In reference to FIG. 3, through the money transfer interface, the user is first prompted to enter the currency transfer amount; the currency transfer amount being the amount of money the user desires to send to the transfer recipient. A currency balance is displayed adjacent to the input field for the currency transfer amount to alert the user of the available funds that can be transferred. In reference to FIG. 19, the digital money transfer application receives the currency transfer amount through the money transfer interface and subtracts the currency transfer amount from the currency balance. If no funds are available, then an upload money icon is displayed instead, wherein the user can select the upload money icon in order to add the desired amount of money to the payments account. In reference to FIG. 21, if the currency transfer amount is greater than the currency balance, then the digital money transfer application prompts the user to input a currency upload amount through the money transfer interface.

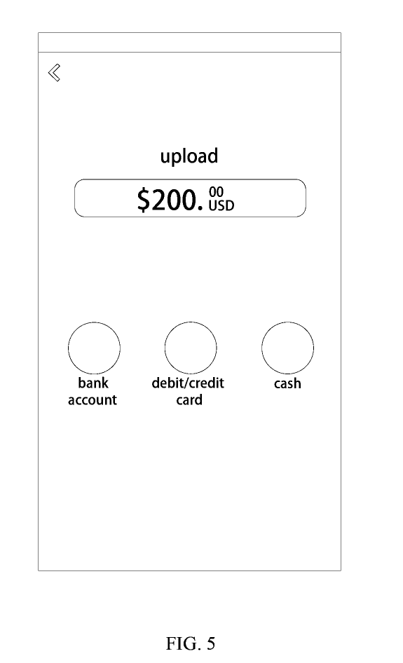

To transfer money from a third party account to the payments account, the user enters the currency upload amount as shown in FIG. 5, wherein the currency upload amount represents the amount of money to be transferred. In reference to FIG. 21, the digital money transfer application receives the currency upload amount through the money transfer interface and passes the currency upload amount to the remote money transfer server. Subsequently, the remote money transfer server transfers the desired amount of money from the third party account to the payments account. The digital money transfer application then increases the currency balance by the currency upload amount to reflect the available funds within the payments account.

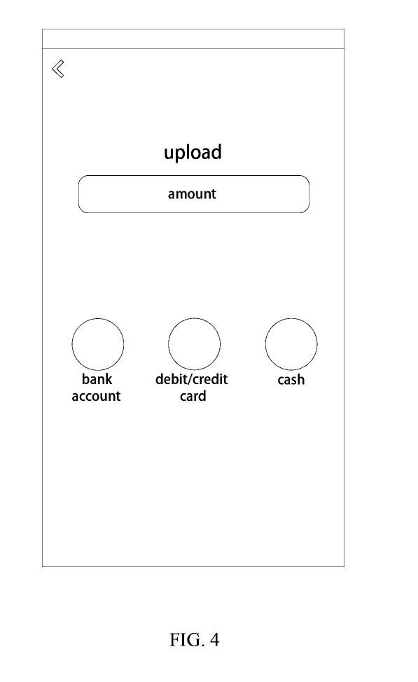

In reference to FIG. 4, the money transfer interface displays a plurality of payment options, wherein the user selects a payment option for the third party account from the plurality of payment options. The third party account from which money is transferred can be a cash account, a credit account, or a digital payment account. Once the user enters the currency upload amount as depicted in FIG. 5, and selects the payment option, the user is then prompted to submit payment processing data, wherein the payment processing data corresponds to the third party account that is selected. The payment processing data includes the information necessary to process the money transfer request and transfer funds from the third party account to the payments account.

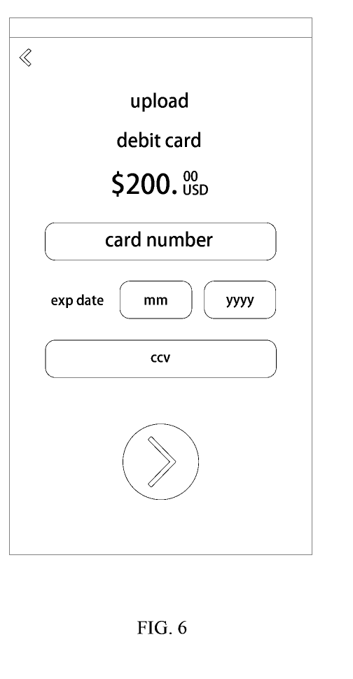

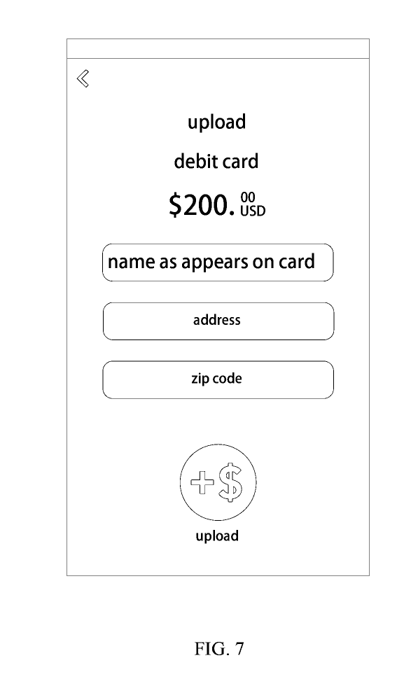

For the third party account being a cash account such as a bank account, the payment processing data can include an account number, a routing number, and an account name. Or, if the cash account is more specifically a debit account, then the payment processing data can include a card number, an expiration data, a card verification value code, a card name, a billing address, and a zip code for a debit card corresponding to the debit account, as depicted in FIG. 6-7. Similarly, for the third party account being a credit account, the payment processing data can include a card number, an expiration data, a card verification value code, a card name, a billing address, and a zip code for a credit card corresponding to the credit account.

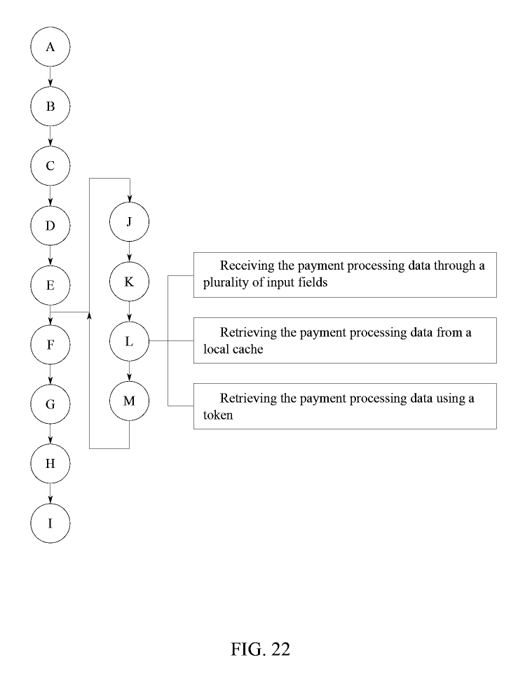

The first time the cash account or the credit account is used, the payment processing data must be entered by the user. In reference to FIG. 6-7, the money transfer interface provides a plurality of input fields through which the user can enter the information required for the payment processing data, wherein the digital money transfer application receives the payment processing data through the plurality of input fields per the flowchart in FIG. 22. In reference to FIG. 21, the payment processing data is then authorized in order to digitally transfer funds from the third party account to the payments account in an increment equal to the currency upload amount. The payment processing data can be authorized directly through the digital money transfer application, authorized on the remote money transfer server, or authorized through a combination thereof.

Once the payment processing data has been entered into the plurality of input fields, the payment processing data can be stored in a local cache either on the personal computing device or the remote money transfer server. By storing the payment processing data in the local cache, the digital money transfer application can utilize the payment processing data for a subsequent money transfer without the user needing to re-enter the payment processing data for the third party account. In reference to FIG. 22, when the third party account is selected a subsequent time, the digital money transfer application retrieves the payment processing data from the local cache. The digital money transfer application then displays the payment processing data through the money transfer interface, wherein the user can confirm that the payment processing data for the third party account is correct.

For the third party account being a digital payment account, the payment processing data is retrieved using a token, wherein the token is stored on the personal computing device. When the user selects the payment option for the digital payment account, the digital money transfer application prompts the user to submit verification in order to authenticate the user. The user can be authenticated using biometric inputs (e.g. fingerprint scanning or facial scanning), motion inputs (e.g. detecting motion through accelerometers or gyroscopes), personal identification number (PIN), or other unique identifier. In reference to FIG. 22, if the user is successfully authenticated, then the digital money transfer application retrieves the token and sends the token to an institution of the third party account via the remote money transfer server. The token is then detokenized by the institution, wherein the payment processing data is authorized in order to digitally transfer funds in an increment equal to the currency upload amount. It is also possible for the token to be detokenized on the remote money transfer server, wherein the remote money transfer server then authorizes the payment processing data.

Money can also be transferred to the payments account using a cash voucher. The user can purchase the cash voucher from a physical location through a cash transaction, wherein the cash voucher provides a cash transaction code. The cash voucher is purchased for a value equal to the currency upload amount desired by the user. The cash transaction code is then entered through the money transfer interface as the payment processing data. The digital money transfer application receives the cash transaction code and validates the cash transaction code. If the cash transaction code is authorized, then funds are digitally transferred to the payments account in an increment equal to the currency upload amount.

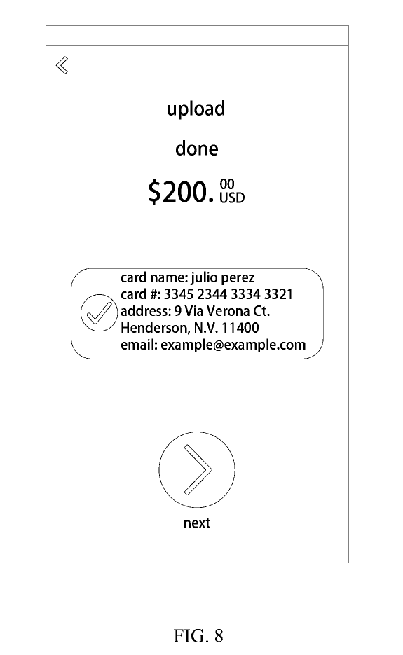

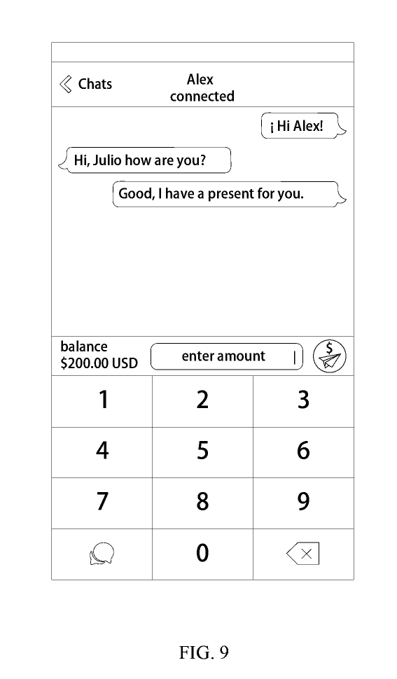

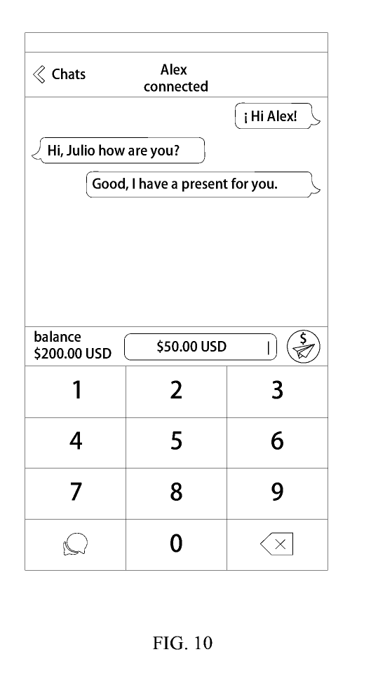

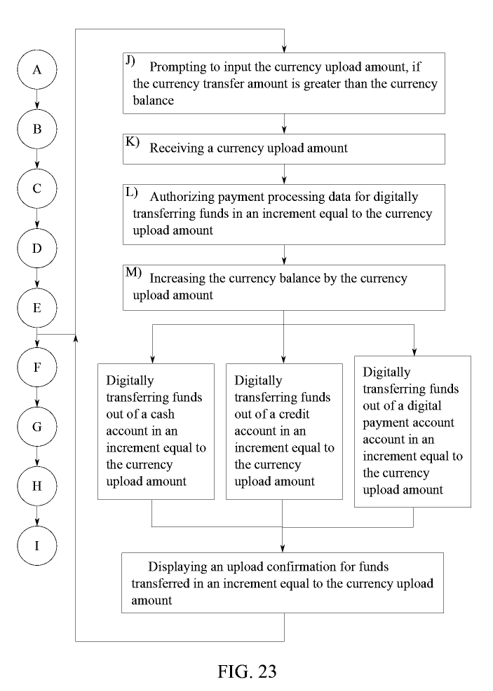

In reference to FIG. 23, once the payment processing data is authorized funds are digitally transferred out of either the cash account, the credit account, or the digital payment account in an increment equal to the currency upload amount. The funds are then digitally transferred into the payments account and the currency balance is updated in order to reflect the available funds that can be transferred by the user to the transfer recipient. The digital money transfer application then displays an upload confirmation for the funds transferred in the increment equal to the currency upload amount, as depicted in FIG. 8. The currency balance is then displayed through the money transfer interface, adjacent to the currency transfer amount, as depicted in FIG. 9-10. Both the currency balance and the currency transfer amount are displayed in a first currency (e.g. United States dollars, Mexico pesos, Japan yen).

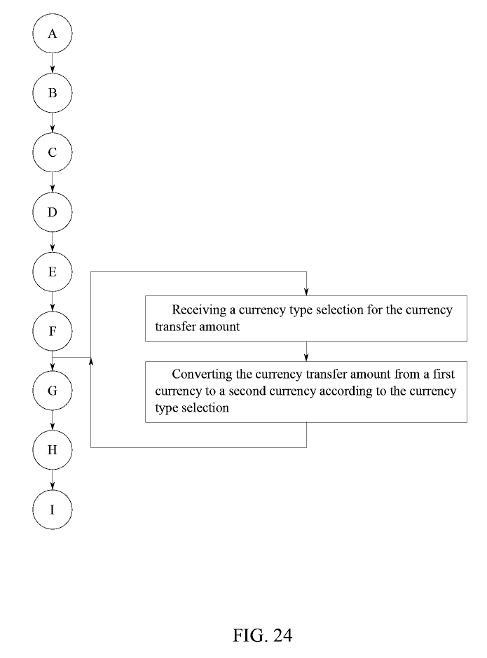

The first currency is the default currency of digital money transfer application. The first currency can be set by the user, or automatically by the digital money transfer application using location based settings of the personal computing device. By selecting a currency type icon displayed through the money transfer interface, the user is able to make a currency type selection for converting the currency transfer amount into a second currency. When the user selects the currency type icon, a plurality of currency options is presented from which the user can make the currency type selection. In reference to FIG. 24, the digital money transfer application receives the currency type selection for the currency transfer amount through the money transfer interface, wherein the digital money transfer application then converts the currency transfer amount from the first currency to the second currency according to the currency type selection.

As an example, the currency balance and the currency transfer amount are initially displayed in the first currency being United States dollars. The user then selects the currency type icon, wherein a drop down menu is presented, displaying the plurality of currency options. The user then makes the currency type selection for the second currency being Mexico pesos. The digital money transfer application then converts the currency transfer amount from United States dollars to Mexico pesos and displays the currency transfer amount in the second currency through the money transfer interface. Subsequently, when money is transferred to the transfer recipient, the currency transfer amount is displayed to the transfer recipient in both the first currency and the second currency.

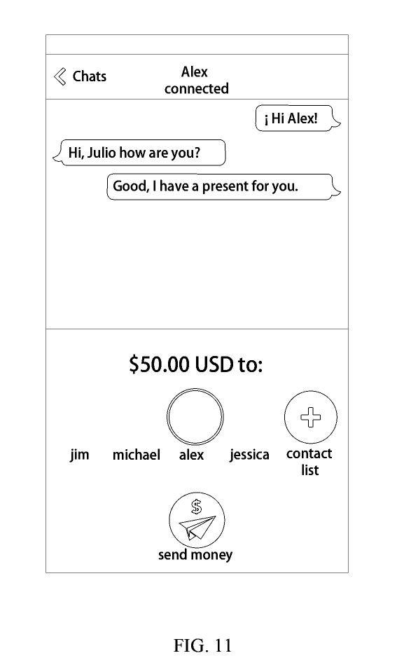

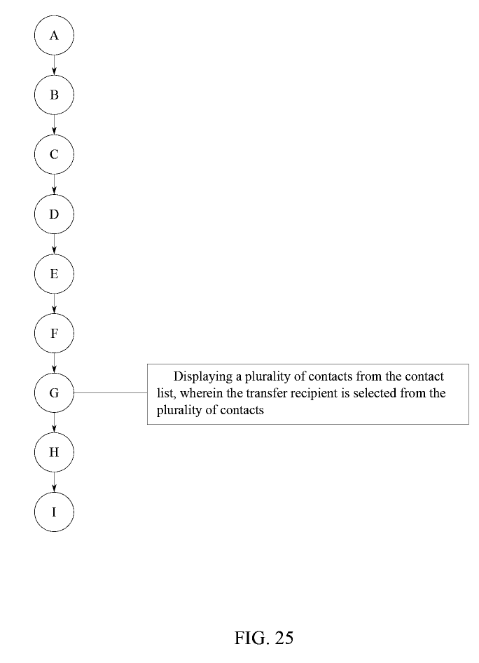

In reference to FIG. 19, when the currency transfer amount has been entered and confirmed, the user is then prompted to select the transfer recipient as shown in FIG. 11. In reference to FIG. 25, the digital money transfer application retrieves a plurality of contacts from the contact list of the digital messaging application and displays the plurality of contacts through the money transfer interface. The user can then make a recipient selection from the plurality of contacts in order to choose the transfer recipient. By default the individual whom the user is having the conversation with through the digital messaging application is recommended as the transfer recipient. However, the user may select another individual from the plurality of contacts.

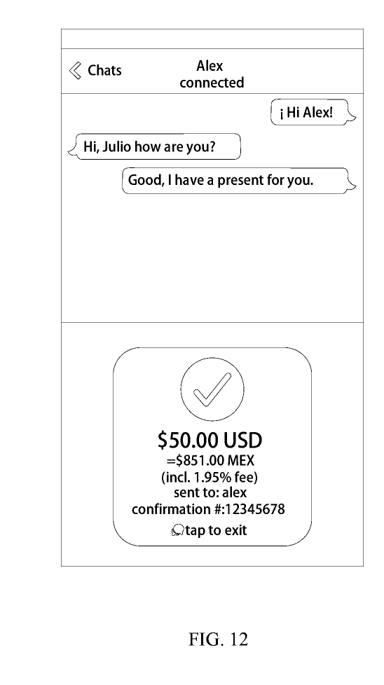

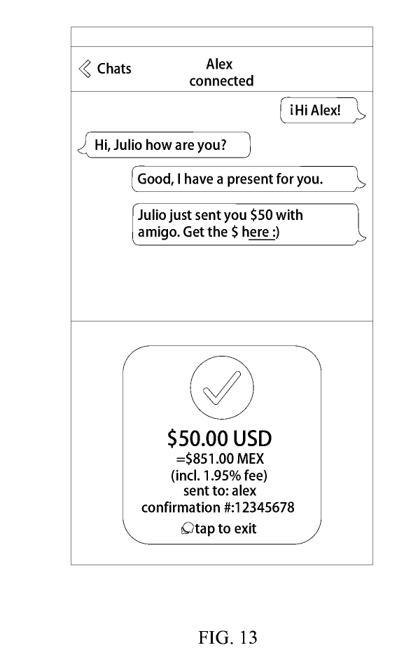

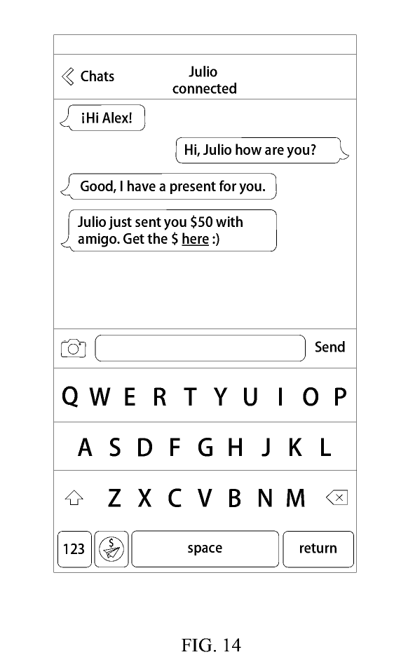

In reference to FIG. 19, the digital money transfer application receives the recipient selection through the money transfer interface and proceeds to generate a money transfer confirmation for the currency transfer amount. The digital money transfer application then sends the money transfer confirmation to the transfer recipient through the digital messaging application as shown in FIG. 13-14, and displays a transfer confirmation to the user through the money transfer interface as shown in FIG. 12. The transfer confirmation displays the transfer recipient, the currency transfer amount, and a confirmation number.

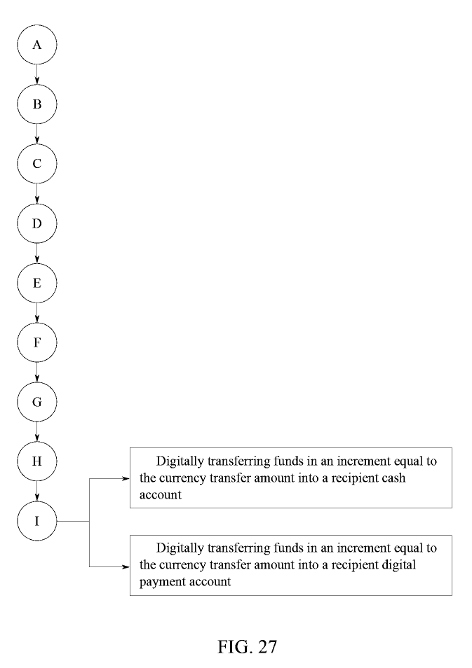

The money transfer confirmation displays the currency transfer amount and the name of the user who transferred the funds to the transfer recipient. In reference to FIG. 27, funds are digitally transferred into a subsequent third party account of the transfer recipient, wherein the money transfer confirmation notifies the transfer recipient that the funds have been deposited into the subsequent third party account and are available for withdraw. The subsequent third party account can be a recipient cash account such as a bank account or debit account; or a recipient digital payment account such as a credit account, cash card account, or other digital payment account. The subsequent third party account may be a default account selected by the transfer recipient, or the subsequent third party account may be selected by the user who is transferring funds to the transfer recipient. In this way, the funds can be automatically transferred with no action required from the transfer recipient.

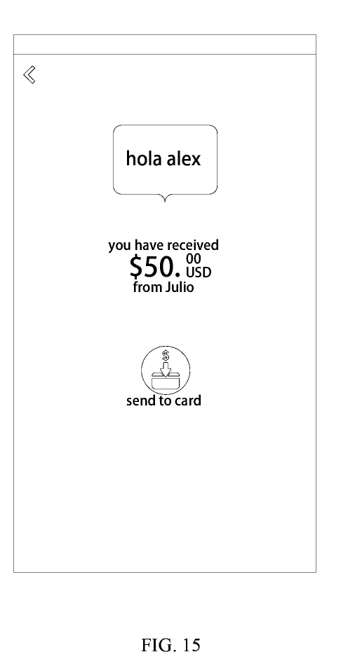

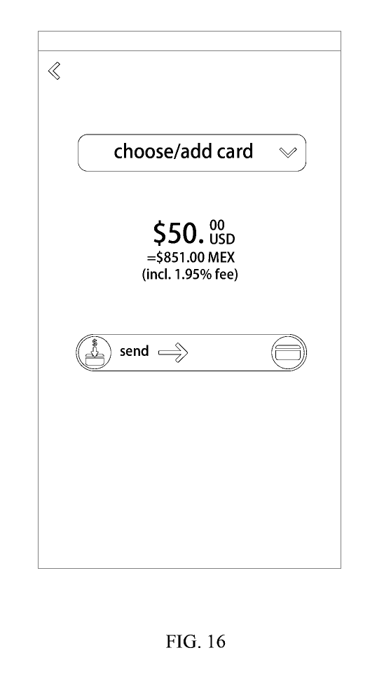

It is also possible for the money transfer confirmation to include a transfer link. In such a case, the transfer recipient has a subsequent personal computing device through which the money transfer confirmation is sent to the transfer recipient. Both the digital money transfer application and the digital messaging application are run on the subsequent personal computing device. The transfer link is displayed within the money transfer confirmation through the digital messaging application on the subsequent personal computing device. When the transfer recipient selects the transfer link, the transfer recipient is prompted to select the subsequent third party account through the digital money transfer application on the subsequent personal computing device as shown in FIG. 15-16.

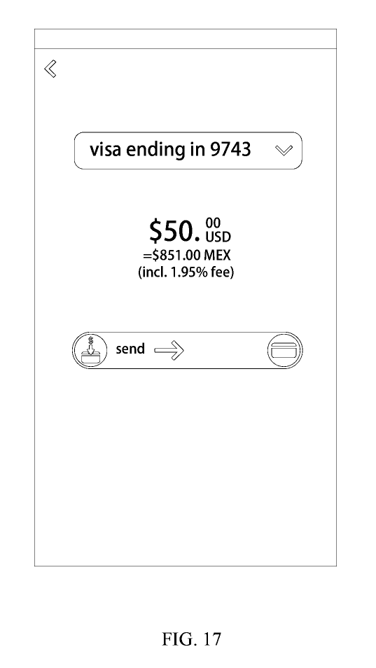

The transfer recipient then selects the subsequent third party account into which the transfer recipient wishes to deposit the funds equal to the currency transfer amount. The subsequent third party account can be a recipient cash account or a recipient digital payment account. The transfer recipient makes an account selection through the money transfer interface on the subsequent personal computing device as shown in FIG. 16-17, wherein the transfer recipient is then prompted to provide account details for the subsequent third party account.

For the subsequent third party account being a recipient cash account such as a bank account, the account details can include an account number, a routing number, an account name, or a debit card number. For the subsequent third party account being a recipient digital payment account, the account details can be provided through a token, wherein the token is stored on the subsequent personal computing device. The digital money transfer application on the subsequent personal computing device receives verification from the transfer recipient in order to authenticate the transfer recipient and utilize the token.

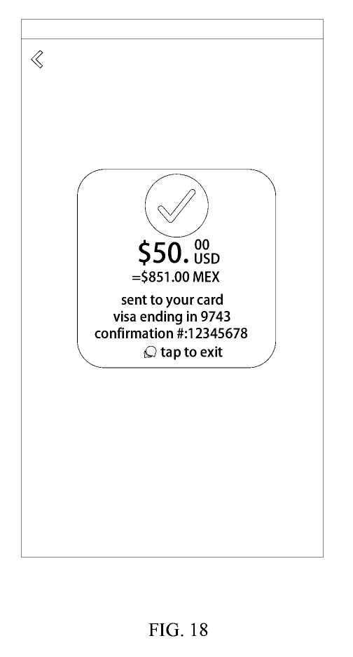

Once the digital money transfer application on the subsequent personal computing device receives the account selection and the account details, the account selection and the account details are forwarded to the remote money transfer server. The remote money transfer server then authorizes the transaction and digitally transfers funds from the payments account in an increment equal to the currency transfer amount into either the recipient cash account or the recipient digital payment account. The recipient digital payment account can be used to physically receive money at a physical location by being linked to or made accessible through an automatic teller machine, or similar infrastructure. A fund deposited confirmation is then displayed to the transfer recipient, as shown in FIG. 18.

Although the invention has been explained in relation to its preferred embodiment, it is to be understood that many other possible modifications and variations can be made without departing from the spirit and scope of the invention as hereinafter claimed.

What is claimed is:

1. A method for providing an encapsulated digital remittance solution by executing computer-executable instructions stored on a non-transitory computer-readable medium, the method comprises the steps of:
providing a remote money transfer server and a digital money transfer application installed on a personal computing device;
integrating a money transfer shortcut into the personal computing device;
launching the digital money transfer application within a digital messaging application, if the money transfer shortcut is selected;
initiating an encrypted connection between the personal computing device and the remote money transfer server;
receiving a currency transfer amount;
subtracting the currency transfer amount from a currency balance;
receiving a recipient selection for a transfer recipient from a contact list of the digital messaging application;
generating a for the currency transfer amount; and
sending the money transfer confirmation to the transfer recipient through the digital messaging application.

2. The method for providing an encapsulated digital remittance solution by executing computer-executable instructions stored on a non-transitory computer-readable medium, the method as claimed in claim 1 further comprises the steps of:
integrating the money transfer shortcut into a digital interface of the digital messaging application.

3. The method for providing an encapsulated digital remittance solution by executing computer-executable instructions stored on a non-transitory computer-readable medium, the method as claimed in claim 2, wherein the digital interface is a digital keyboard.

4. The method for providing an encapsulated digital remittance solution by executing computer-executable instructions stored on a non-transitory computer-readable medium, the method as claimed in claim 1 further comprises the steps of:
receiving a currency upload amount; and
increasing the currency balance by the currency upload amount.

5. The method for providing an encapsulated digital remittance solution by executing computer-executable instructions stored on a non-transitory computer-readable medium, the method as claimed in claim 4 further comprises the steps of:
prompting to input the currency upload amount, if the currency transfer amount is greater than the currency balance.

6. The method for providing an encapsulated digital remittance solution by executing computer-executable instructions stored on a non-transitory computer-readable medium, the method as claimed in claim 4 further comprises the steps of:
authorizing payment processing data for digitally transferring funds in an increment equal to the currency upload amount.

7. The method for providing an encapsulated digital remittance solution by executing computer-executable instructions stored on a non-transitory computer-readable medium, the method as claimed in claim 6 further comprises the steps of:
receiving the payment processing data through a plurality of input fields.

8. The method for providing an encapsulated digital remittance solution by executing computer-executable instructions stored on a non-transitory computer-readable medium, the method as claimed in claim 6 further comprises the steps of:
retrieving the payment processing data from a local cache.

9. The method for providing an encapsulated digital remittance solution by executing computer-executable instructions stored on a non-transitory computer-readable medium, the method as claimed in claim 6 further comprises the steps of:
retrieving the payment processing data using a token.

10. The method for providing an encapsulated digital remittance solution by executing computer-executable instructions stored on a non-transitory computer-readable medium, the method as claimed in claim 4 further comprises the steps of:
digitally transferring funds out of a cash account in an increment equal to the currency upload amount.

11. The method for providing an encapsulated digital remittance solution by executing computer-executable instructions stored on a non-transitory computer-readable medium, the method as claimed in claim 4 further comprises the steps of:
digitally transferring funds out of a credit account in an increment equal to the currency upload amount.

12. The method for providing an encapsulated digital remittance solution by executing computer-executable instructions stored on a non-transitory computer-readable medium, the method as claimed in claim 4 further comprises the steps of:
digitally transferring funds out of a digital payment account in an increment equal to the currency upload amount.

13. The method for providing an encapsulated digital remittance solution by executing computer-executable instructions stored on a non-transitory computer-readable medium, the method as claimed in claim 4 further comprises the steps of:
displaying an upload confirmation for funds transferred in an increment equal to the currency upload amount.

14. The method for providing an encapsulated digital remittance solution by executing computer-executable instructions stored on a non-transitory computer-readable medium, the method as claimed in claim 1 further comprises the steps of:
receiving a currency type selection for the currency transfer amount; and
converting the currency transfer amount from a first currency to a second currency according to the currency type selection.

15. The method for providing an encapsulated digital remittance solution by executing computer-executable instructions stored on a non-transitory computer-readable medium, the method as claimed in claim 1 further comprises the steps of:
displaying a plurality of contacts from the contact list, wherein the transfer recipient is selected from the plurality of contacts.

16. The method for providing an encapsulated digital remittance solution by executing computer-executable instructions stored on a non-transitory computer-readable medium, the method as claimed in claim 1 further comprises the steps of:
validating that the personal computing device is a registered device; and
terminating the encrypted connection between the personal computing device and the remote money transfer server, if the personal computing device is not the registered device.

17. The method for providing an encapsulated digital remittance solution by executing computer-executable instructions stored on a non-transitory computer-readable medium, the method as claimed in claim 1 further comprises the steps of:
digitally transferring funds in an increment equal to the currency transfer amount into a recipient cash account.

18. The method for providing an encapsulated digital remittance solution by executing computer-executable instructions stored on a non-transitory computer-readable medium, the method as claimed in claim 1 further comprises the steps of:
digitally transferring funds in an increment equal to the currency transfer amount into a recipient digital payment account.

19. The method for providing an encapsulated digital remittance solution by executing computer-executable instructions stored on a non-transitory computer-readable medium, the method as claimed in claim 1, wherein the money transfer shortcut is a voice command.

20. The method for providing an encapsulated digital remittance solution by executing computer-executable instructions stored on a non-transitory computer-readable medium, the method as claimed in claim 1, wherein the money transfer shortcut is a motion command.
